(19) United States
(12) Patent Application Publication
(10) Pub. No.: US 2025/0107510 A1
(43) Pub. Date: Apr. 3, 2025

(54) SMALL INSECT FILTER GRID

(71) Applicant: Dan Hood, Windermere, FL (US)

(72) Inventor: Dan Hood, Windermere, FL (US)

(21) Appl. No.: 18/375,503

(22) Filed: Sep. 30, 2023

(51) Int. Cl. A01K 47/06; A01M 29/28; H02J 9/06

(52) U.S. Cl. CPC A01K 47/06; A01M 29/28; H02J 9/06

(57) ABSTRACT

A small insect filter grid may spare bugs of a smaller size and kill larger bugs. The small insect filter grid may protect and spare a honeybee colony while killing the Asian Giant Hornet which can decimate a honeybee population. The small insect filter grid may provide a protective cage having a mesh grid pattern that may be placed around a honeybee hive. The protective cage may be electrically powered to kill the larger bugs such as the Asian Giant Hornet. The honeybees and other smaller insects are not large enough to touch both a positive (+) and a negative (−) rail of the mesh at the same time, and accordingly, will not bridge the circuit to activate the power within the grid and be electrocuted. Asian Giant Hornets are large enough to touch both the positive and negative rails to bridge the circuit so that they are electrocuted.

### FIELD OF THE DISCLOSURE

The present disclosure generally relates to honeybee protection, and more particularly to a small insect filter grid.

### BACKGROUND

The Asian giant hornet, also referred to as a “murder hornet” or a “death hornet,” have been known to be an invasive species of insect that attack honeybees. They crawl into hives and rip off the heads of bees in large numbers, possibly decimating a hive in a matter of hours. Accordingly, government agencies and beekeepers need to find ways to protect against this non-native invasive species.

### SUMMARY

Embodiments of the present disclosure may provide a small insect filter grid comprising: a protective cage having a mesh grid pattern that surrounds a beehive, the protective cage comprising: a non-conductive material that forms the mesh grid pattern; a plurality of positive rails; and a plurality of negative rails, the plurality of positive rails and the plurality of negative rails alternating and interspersed within the non-conductive material; an electric cage driver circuit that may power the protective cage when one of the plurality of positive rails and one of the plurality of negative rails are contacted at the same time by a large insect to electrocute the large insect; and a power source that may power the electric cage driver circuit, wherein honeybees enter and leave the protective cage without one of the plurality of positive rails and one of the plurality of negative rails being contacted at the same time. The non-conductive material may be nylon. The power source may be at least one solar panel and a battery as a backup power source. The at least one solar panel may power the protective cage and charge the battery during daylight hours and the protective cage may remain powered through the battery in nighttime hours. The power source may be alternating current (AC) power. A pitch of the mesh grid may be adjustable. The protective cage may be provided in a plurality of sizes to accommodate different beehive configurations.

Other embodiments of the present disclosure may provide a protective mesh grid surrounding a beehive, the protective mesh grid comprising: a non-conductive material that forms a mesh grid pattern; a plurality of positive rails; and a plurality of negative rails, the plurality of positive rails and the plurality of negative rails alternating and interspersed within the non-conductive material, wherein when one of the plurality of positive rails and one of the plurality of negative rails are contacted at the same time by a large insect, the large insect is electrocuted, and wherein honeybees enter and leave the protective mesh grid without one of the plurality of positive rails and one of the plurality of negative rails being contacted at the same time. An electric cage driver circuit may power the protective mesh grid to electrocute the large insect. A power source may power the electric cage driver circuit. The power source may be at least one solar panel and a battery as a backup power source. The at least one solar panel may power the protective mesh grid and charge the battery during daylight hours and the protective mesh grid may remain powered through the battery in nighttime hours. The power source may be alternating current (AC) power.

### BRIEF DESCRIPTION OF THE DRAWINGS

For a more complete understanding of this disclosure, reference is now made to the following description, taken in conjunction with the accompanying drawings, in which:

FIG. 1 depicts a direct current (DC) circuit next to a protective mesh grid according to an embodiment of the present disclosure;

FIG. 2 depicts construction of the protective mesh grid according to an embodiment of the present disclosure;

FIG. 3 depicts a relative size difference between a honeybee and an Asian Giant hornet on a protective mesh grid backdrop according to an embodiment of the present disclosure; and

FIG. 4 depicts a small bug filter cage according to an embodiment of the present disclosure.

### DETAILED DESCRIPTION

Embodiments of the present disclosure may provide a small insect filter grid that may spare bugs of a smaller size and kill larger bugs. In an embodiment of the present disclosure, the small insect filter grid may protect and spare a honeybee colony while killing the Asian Giant Hornet which can decimate a honeybee population.

The small insect filter grid according to embodiments of the present disclosure may provide a protective cage having a mesh grid pattern that may be placed around a honeybee hive. The protective cage may be electrically powered to kill the larger bugs such as the Asian Giant Hornet. The honeybees and other smaller insects may be small enough in size to fit through the smaller holes of the mesh. They are not large enough to touch both a positive (+) and a negative (−) rail of the mesh at the same time, and accordingly, the honeybees and other smaller insects will not bridge the circuit to activate the power within the grid. Thus, the honeybees and other smaller insects will not be electrocuted. It should be appreciated that different mesh sizes may be offered based on different beehive sizes in embodiments of the present disclosure. On the other hand, Asian Giant Hornets are large enough to touch both the positive and negative rails. This may bridge the circuit so that they are electrocuted.

It should be appreciated that the protective mesh grid may provide a first line of defense for any honeybee colony that is to be protected. It also may be inexpensive to build. In embodiments of the present disclosure, the protective mesh grid may be powered through at least one solar panel with a battery backup. The at least one solar panel may power the protective mesh grid and charge the battery during the daylight hours so that the protective mesh grid can remain powered through the battery backup at night. Thus, the small insect filter grid may be utilized in an area not having an immediate power source. In some embodiments of the present disclosure, the off-circuit solar setup may be provided as an optional upgrade to the protective mesh grid.

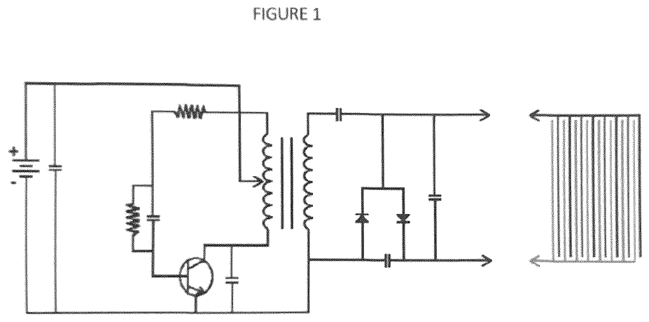

FIG. 1 depicts a direct current (DC) circuit next to a protective mesh grid according to an embodiment of the present disclosure. FIG. 1 depicts how the protective mesh grid may be powered through a DC circuit to electrocute the larger insects.

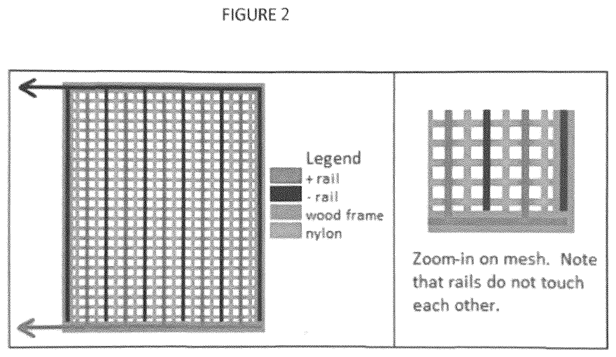

FIG. 2 depicts construction of the protective mesh grid according to an embodiment of the present disclosure. As depicted herein, the frame of the protective mesh grid may be formed of wood; however, other sturdy materials may be used without departing from the present disclosure. Within the frame, the mesh grid may be formed of nylon; however, other non-conductive materials including but not limited to polyester or other mesh fabrics may be used without departing from the present disclosure. Positive and negative voltage rails may then be incorporated within the mesh grid whereby the positive and negative voltage rails may be separated by bars of the mesh grid to create the smaller holes for honeybees to pass through within the frame. The positive and negative rails do not touch one another.

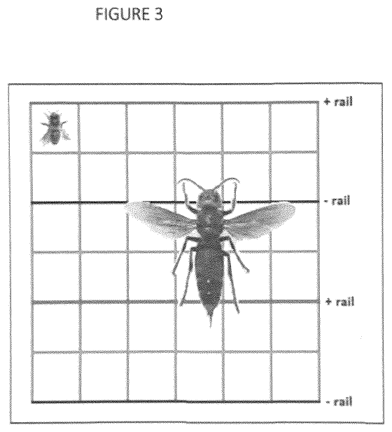

FIG. 3 depicts a relative size difference between a honeybee and an Asian Giant hornet on a protective mesh grid backdrop according to an embodiment of the present disclosure. As depicted herein, a honeybee may pass through a square of the mesh grid that may be small enough so that the honeybee also does not touch a positive or negative rail. In contrast, the Asian Giant Hornet may be large enough in size that it would contact both a positive and a negative rail within the protective mesh grid. Contact with both rails may bridge the circuit causing the Asian Giant Hornet to be electrocuted before it may reach the honeybee hive or colony. In addition, the size of the squares of mesh grid may be small enough in size such that the Asian Giant Hornet cannot easily pass through the mesh grid before it is electrocuted.

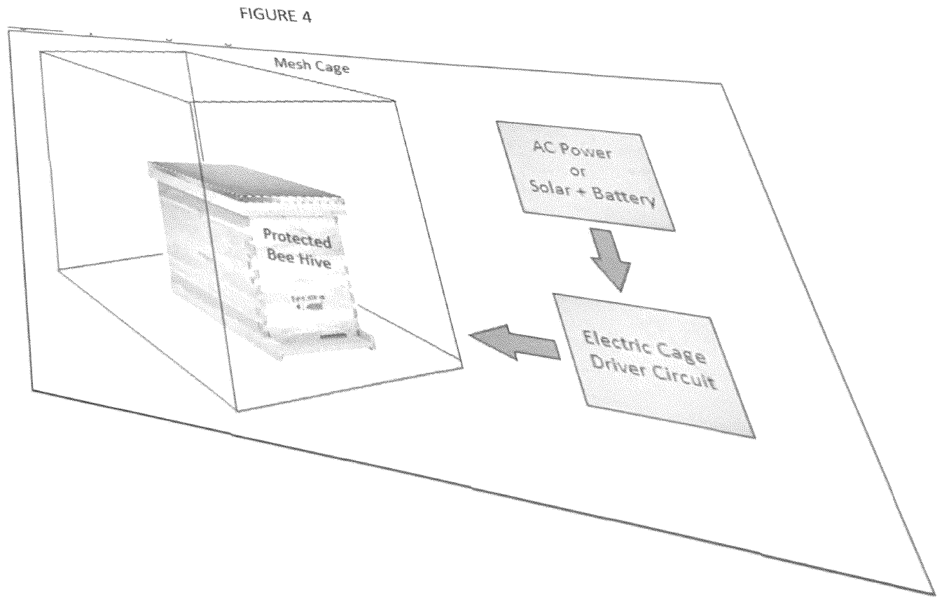

FIG. 4 depicts a small bug filter cage according to an embodiment of the present disclosure. As depicted herein, a cubical cage may be placed around the beehive, protecting the bees inside. The cubical cage may be formed of mesh having the positive and negative rails positioned within the mesh. An electric cage driver circuit may be powered through AC power or at least one solar panel and/or battery, and the electric cage driver circuit may be activated when positive and negative rails are bridged, such as when a larger insect tries to penetrate the mesh cage. It should be appreciated that the grid pitch may be adjusted and the cage size may be provided in a plurality of sizes to accommodate different beehive configurations in embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A small insect filter grid comprising:
a protective cage having a mesh grid pattern that surrounds a beehive, the protective cage comprising:
a non-conductive material that forms the mesh grid pattern;
a plurality of positive rails; and
a plurality of negative rails, the plurality of positive rails and the plurality of negative rails alternating and interspersed within the non-conductive material;
an electric cage driver circuit that powers the protective cage when one of the plurality of positive rails and one of the plurality of negative rails are contacted at the same time by a large insect to electrocute the large insect; and
a power source that powers the electric cage driver circuit, wherein honeybees enter and leave the protective cage without one of the plurality of positive rails and one of the plurality of negative rails being contacted at the same time.

2. The small insect filter grid of claim 1, wherein the non-conductive material is nylon.

3. The small insect filter grid of claim 1, wherein the power source is at least one solar panel and a battery as a backup power source.

4. The small insect filter grid of claim 3, wherein the at least one solar panel powers the protective cage and charges the battery during daylight hours and the protective cage remains powered through the battery in nighttime hours.

5. The small insect filter grid of claim 1, wherein the power source is alternating current (AC) power.

6. The small insect filter grid of claim 1, wherein a pitch of the mesh grid is adjustable.

7. The small insect filter grid of claim 1, wherein the protective cage is provided in a plurality of sizes to accommodate different beehive configurations.

8. A protective mesh grid surrounding a beehive, the protective mesh grid comprising:
a non-conductive material that forms a mesh grid pattern;
a plurality of positive rails; and
a plurality of negative rails, the plurality of positive rails and the plurality of negative rails alternating and interspersed within the non-conductive material,
wherein when one of the plurality of positive rails and one of the plurality of negative rails are contacted at the same time by a large insect, the large insect is electrocuted, and
wherein honeybees enter and leave the protective mesh grid without one of the plurality of positive rails and one of the plurality of negative rails being contacted at the same time.

9. The protective mesh grid of claim 8, wherein an electric cage driver circuit powers the protective mesh grid to electrocute the large insect.

10. The protective mesh grid of claim 9, wherein a power source powers the electric cage driver circuit.

11. The protective mesh grid of claim 10, wherein the power source is at least one solar panel and a battery as a backup power source.

12. The protective mesh grid of claim 10, wherein the at least one solar panel powers the protective mesh grid and charges the battery during daylight hours and the protective mesh grid remains powered through the battery in nighttime hours.

13. The protective mesh grid of claim 10, wherein the power source is alternating current (AC) power.
